(19) United States
(12) Patent Application Publication
(10) Pub. No.: US 2019/0171941 A1
(43) Pub. Date: Jun. 6, 2019

(54) ELECTRONIC DEVICE, ACCELERATOR, AND ACCELERATING METHOD APPLICABLE TO CONVOLUTIONAL NEURAL NETWORK COMPUTATION

(71) Applicant: ABEE TECHNOLOGY CO., LTD., New Taipei City (TW)

(72) Inventors: Nhon-Toai QUACH, New Taipei City (TW); Chung-Chieh CHEN, New Taipei City (TW); Kong-Qiao WANG, New Taipei City (TW); Wen-Fu TSAI, New Taipei City (TW); Tzu-Wei YEH, New Taipei City (TW); Chung-Hao CHENG, New Taipei City (TW); Hui-Min LU, New Taipei City (TW)

(21) Appl. No.: 16/203,686

(22) Filed: Nov. 29, 2018

(30) Foreign Application Priority Data
Dec. 1, 2017 (TW) 106142473

(51) Int. Cl. G06N 3/10; G06F 7/544; G06F 9/48; G06F 1/3234

(52) U.S. Cl. CPC G06N 3/10; G06F 1/3234; G06F 9/4881; G06F 7/5443

(57) ABSTRACT

An electronic device comprises a data transmitting interface configured to transmit data, a memory configured to store the data, a processor configured to execute an application program, and an accelerator coupled to the processor via a bus. According to an operation request transmitted from the processor, the accelerator reads the data from the memory, performs an operation to the data to generate computed data, and stores the computed data in the memory. The electronic device can improve computational efficiency. An accelerator and an accelerating method applicable to a neural network operation are also provided.

### BACKGROUND

### 1. Field of the Disclosure

The present disclosure relates to computational technologies, in particular to an electronic device, an accelerator, and an accelerating method applicable to a neural network operation.

### 2. Description of Related Art

In recent years, convolutional neural network (CNN) technology has seen wide-spread applications and is rapidly becoming an industry trend. Performing CNN operations on a processor, even with its improved computational power, is generally not considered a good idea because of the frequent memory accesses required, which significantly lower its computational efficiency. Conventionally, a graphics processing unit (GPU) is often used instead to accelerate CNN operations. However, GPU has high hardware cost and power consumption, making it difficult to apply to portable devices.

Therefore, there is a need to provide a new scheme for low power applications that require high computational efficiency.

### SUMMARY

The objective of the present disclosure is to provide an electronic device, an accelerator, and an accelerating method applicable to an operation for improving computational efficiency.

In one aspect, the present disclosure provides an electronic device, including: a data transmitting interface configured to transmit data; a memory configured to store the data; a processor configured to execute an application program; and an accelerator coupled to the processor via a bus, and according to an operation request transmitted from the processor, the accelerator is configured to read the data from the memory, perform an operation to the data to generate computed data, and store the computed data in the memory, wherein the processor is in a power saving state when the accelerator performs the operation.

In another aspect, the present disclosure provides an accelerator for performing a neural network operation to data in a memory, including: a register configured to store a plurality of parameters related to the neural network operation; a reader/writer configured to read the data from the memory; a controller coupled to the register and the reader/writer; and an arithmetic unit coupled to the controller, based on the parameters, the controller controlling the arithmetic unit to perform the neural network operation to the data to generate computed data.

In still another aspect, an accelerating method applicable to a neural network operation, including: (a) receiving data; (b) utilizing a processor to execute a neural network application program; (c) in execution of the neural network application program, storing the data in a memory and sending a first signal to an accelerator; (d) using the accelerator to perform the neural network operation to generate computed data; (e) sending a second signal to the processor by using the accelerator after the neural network operation is accomplished; (f) continuing executing the neural network application program using the processor; and (g) determining whether to run the accelerator; if yes, the processor sends a third signal to the accelerator and goes back to step (d); if no, terminate the process.

In the present disclosure, the processor delivers some operations (e.g., CNN operations) to the accelerator. This can reduce the time to access the memory and improve computational efficiency. Moreover, in some embodiments, when the accelerator performs the operation, the processor is in power saving state. Accordingly, this can efficiently reduce power consumption.

### BRIEF DESCRIPTION OF DRAWINGS

FIG. 1 is a schematic diagram showing an electronic device in accordance with the present disclosure.

FIG. 2 is a schematic diagram showing an electronic device in accordance with a first embodiment of the present disclosure.

FIG. 3 is a schematic diagram showing an electronic device in accordance with a second embodiment of the present disclosure.

FIG. 4 is a schematic diagram showing an electronic device in accordance with a third embodiment of the present disclosure.

FIG. 5 is a schematic diagram showing an electronic device in accordance with a fourth embodiment of the present disclosure.

FIG. 6 is a schematic diagram showing a CNN accelerating system in accordance with the present disclosure.

FIG. 7 is a schematic diagram showing an accelerator, a processor, and a memory in accordance with the present disclosure.

FIG. 8 is a schematic diagram showing the accelerator of the present disclosure in more detail.

FIG. 9 is a flow chart of an accelerating method applicable to a CNN operation in accordance with the present disclosure.

### DETAILED DESCRIPTION OF PREFERRED EMBODIMENTS

To further clarify the objectives, technical schemes, and technical effects of the present disclosure, the present disclosure will be described in details below by using embodiments in conjunction with the appended drawings. It should be understood that the specific embodiments described herein are merely for explaining the present disclosure, and as used herein, the term “embodiment” refers to an instance, an example, or an illustration but is not intended to limit the present disclosure. In addition, the articles “a” and “an” as used in the specification and the appended claims should generally be construed to mean “one or more” unless specified otherwise or is clear from the context to be directed to a singular form. Also, in the appended drawings, the components having similar or the same structure or function are indicated by the same reference number.

The present disclosure provides an electronic device, which is featured in splitting some operations from a processor. Particularly, these operations are related to convolutional neural network (CNN) operations. The electronic device of the present disclosure can improve computational efficiency dramatically.

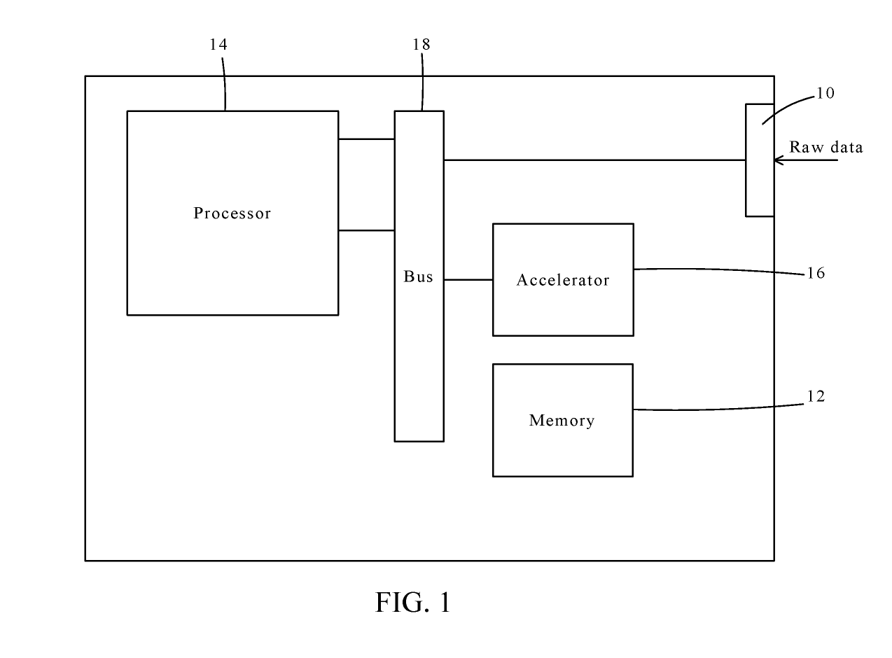

Referring to FIG. 1, the electronic device of the present disclosure includes a data transmitting interface 10, a memory 12, a processor 14, an accelerator 16, and a bus 18. The data transmitting interface 10 is used to transmit raw data. The memory 12 is used to store the raw data. The memory 12 can be implemented by a static random access memory (SRAM). The data transmitting interface 10 transmits the raw data to the memory 12 to store the raw data. The raw data is for example a sensing data captured by a sensor (not shown), e.g., an electrocardiography (ECG) data. The data transmitting interface 10 can meet the standards such as Inter-Integrated Circuit bus (I2C), Serial Peripheral Interface (SPI), General-purpose Input/Output (GPIO), and Universal Asynchronous Receiver/Transmitter (UART).

The processor 14 is used to execute an application program such as a neural network application program, and more particularly, a CNN application program. The processor 14 is coupled to the accelerator 16 via the bus 18. When the processor 14 requires to perform an operation, for example, an operation related to a CNN operation such as Convolution operation, Rectified Linear Units (ReLu) operation, and Max Pooling operation, the processor 14 sends an operation request to the accelerator 16 via the bus 18. The bus 18 can be implemented by Advanced High-Performance Bus (AHB).

The accelerator 16 receives the operation request from the processor 14 via the bus 18. When the operation request is received by the accelerator 16, the accelerator 16 reads the raw data from the memory 12, performs an operation to the raw data to generate computed data, and store the generated computed data in the memory 12. For example, the operation is a convolution operation. The convolution operation is the most complicated operation in CNN. For the convolution operation, the accelerator 16 multiplies each record of the raw data by a weight coefficient and then sums them up. It can also add a bias to the sum as an output. The result can propagate to a next CNN layer, serving as an input. For example, the result can propagate to a convolutional layer and the convolution operation is performed once again in the convolutional layer. Its output serves as an input of a next layer. The next layer can be a ReLu layer, a max pooling layer, or an average pooling layer. A full connected layer can be connected before a final output layer.

The operations performed by the accelerator 16 are not limited in taking the raw data as an input and directly operating the raw data. The operations performed by the accelerator 16 can be the operations required by each layer of the neural network, for example, the afore-mentioned Convolution operation, ReLu operation, and Max Pooling operation.

The above-mentioned raw data may be processed and optimized in a front end to generate a data, which is then stored in the memory 12. For example, the raw data may be processed with filtering, noise reduction, and time-frequency domain conversion in the front end, and then stored in the memory 12. The accelerator 16 performs the afore-mentioned operation to the processed data. In this article, the raw data may not be limited to the data retrieved from the sensor but referred broadly to any data that is transmitted to the accelerator 16 to be computed.

The electronic device can be carried out by System on Chip (SoC). That is, the data transmitting interface 10, the memory 12, the processor 14, the accelerator 16, and the bus 18 can be integrated into the SoC.

In the electronic device of the present disclosure, the processor 14 delivers some operations to the accelerator 16. This can reduce processor load, increase utilization of the processor 14, and reduce latency, and can also reduce cost of the processor 14 in some applications. If the operations related to CNN applications were processed using the processor 14, it would have taken too much time for the processor 14 to access the memory 12 leading to longer processing time. In the electronic device of the present disclosure, the accelerator 16 is in charge of the operations related to the neural network. One advantage in this aspect is that the memory access time is reduced. For example, in a situation that the processor 14 is running at twice the operational frequency of the accelerator 16 and the memory 12, the accelerator 16 will be able to access the content of the memory 12 in one cycle while it takes up to 10 cycles for the processor 14. Accordingly, deployment of the accelerator 16 can efficiently improve computational efficiency.

Another advantage of the present disclosure is that the electronic device can efficiently reduce power consumption. Specifically, when the accelerator 16 performs the operation, the processor 14 is idle and can be optionally put into a power saving state. The processor 14 operates under an operation mode and a power saving mode. When the accelerator 16 performs the operation, the processor 14 is in the power saving mode. In the power saving state or the power saving mode, the processor 14 can be in an idle state waiting for external interrupt, or in a low clock state, that is, the clock is lowered or completely disabled in the power saving mode. In one embodiment, when changed from the operation mode to the power saving mode, the processor 14 gets into the idle state and its clock is lowered to a low clock or completely disabled. In a situation that the processor 14 is running at an operational frequency or clock higher than the accelerator 16, the processor 14 consumes more power than the accelerator 16. In the embodiments of the present disclosure, the processor 14 gets into the power saving mode when the accelerator 16 perform the operation. Accordingly, this can efficiently reduce power consumption, and is beneficial to wearable device applications, for example.

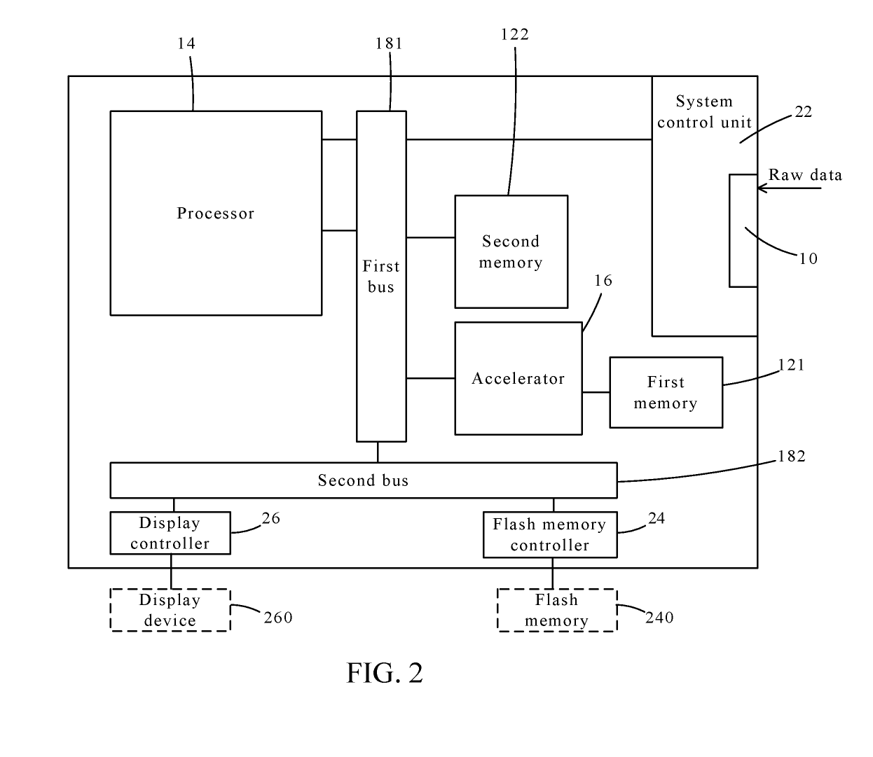

FIG. 2 is a schematic diagram showing an electronic device in accordance with a first embodiment of the present disclosure. In the first embodiment, the electronic device includes a processor 14, an accelerator 16, a first memory 121, a second memory 122, a first bus 181, a second bus 182, a system control unit (SCU) 22, and a data transmitting interface 10. For example, the first bus 181 is AHB and the second bus 182 is Advanced Performance/Peripherals Bus (APB). Transmission speed of the first bus 181 is higher than the transmission speed of the second bus 182. The accelerator 16 is coupled to the processor 14 via the first bus 181. The first memory 121 is directly connected to the accelerator 16. The second memory 122 is coupled to the processor 14 via the first bus 181. For example, both the first memory 121 and the second memory 122 are SRAMs.

In one embodiment, the raw data or the data can be stored in the first memory 121 and the computed data generated by performing the operation by the accelerator 16 can be stored in the second memory 122. Specifically, the processor 14 transmits the data to the accelerator 16. The accelerator 16 receives the data via the first bus 181 and writes the data to the first memory 121. The computed data generated by the accelerator 16 is written to the second memory 122 via the first bus 181.

In another embodiment, the raw data or the data can be stored in the second memory 122 and the computed data generated by performing the operation by the accelerator 16 can be stored in the first memory 121. Specifically, the data is written to the second memory 122 via the first bus 181. The computed data generated by the accelerator 16 is directly written to the first memory 121.

In still another embodiment, both the data and the computed data store in the first memory 121. The second memory 122 is used to store the data related to the application program executed by the processor 14. For example, the second memory 122 stores related data (e.g., program data) required by a convolutional neural network application program running on the processor 14. In this embodiment, the processor 14 transmits the data for operation to the accelerator 16. The accelerator 16 receives the data via the first bus 181 and writes the data to the first memory 121. The computed data generated by the accelerator 16 is directly written to the first memory 121.

The processor 14 and the accelerator 16 can share the first memory 121. The processor 14 can write the data into the first memory 121 and read the data from the first memory 121 via the accelerator 16. The accelerator 16 has priority over the processor 14 when accessing the first memory 121.

In the first embodiment, the electronic device further includes a flash memory controller 24 and a display controller 26 coupled to the second bus 182. The flash memory controller 24 is configured to be coupled to a flash memory 20 external to the electronic device. The display controller 26 is configured to be coupled to a display device 260 external to the electronic device. That is, the electronic device can be coupled to the flash memory 240 to achieve an external memory access function and coupled to the display device 260 to achieve a display function.

The system control unit 22 is coupled to the processor 14 via the first bus 181. The system control unit 22 can manage system resources and control activities between the processor 14 and other components. In another embodiment, the system control unit 22 can be integrated into the processor 14 as a component of the processor 14. Specifically, the system control unit 22 can control the processor clock, or operational frequency of the processor 14. In the present disclosure, the system control unit 22 is used to lower the processor clock or completely disable the clock to make the processor 14 get into the power saving mode from the operation mode. Similarly, the system control unit 22 is used to increase the processor clock to common clock frequency to make the processor 14 get into the operation mode from the power saving mode. In another aspect, when the accelerator 16 performs the operation, a firmware driver may be used to send a wait-for-interrupt (WFI) instruction to the processor 14 to put the processor 14 into the idle state.

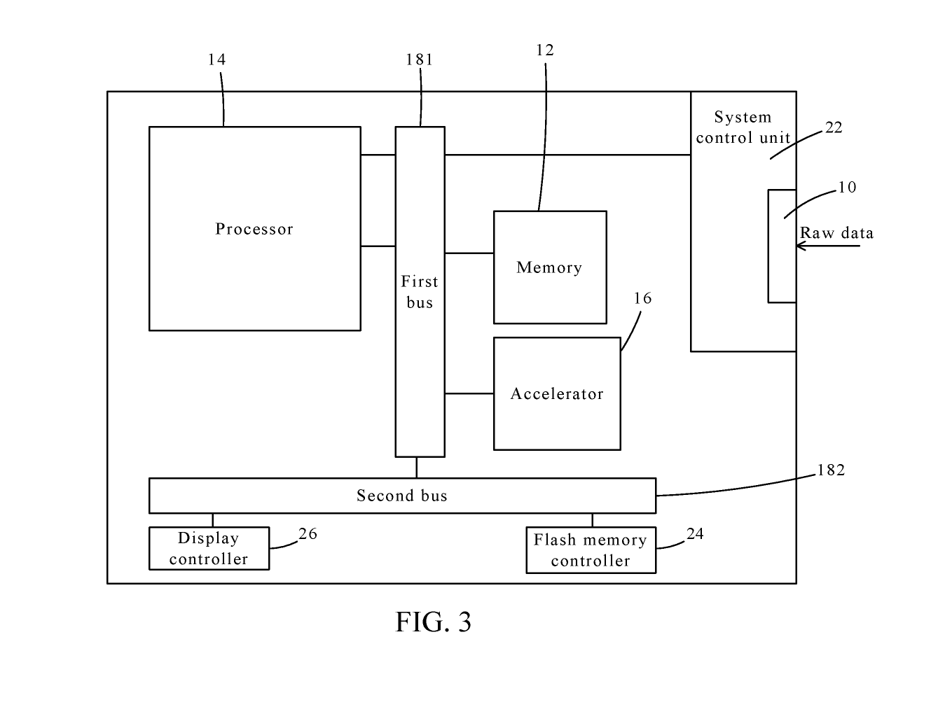

FIG. 3 is a schematic diagram showing an electronic device in accordance with a second embodiment of the present disclosure. Compared with the first embodiment, the second embodiment only deploys a memory 12 coupled to the processor 14 and the accelerator 16 via the first bus 181. In the second embodiment, both the data and the computed data store in the memory 12. Specifically, the processor 14 stores the raw data transmitted from the transmitting interface or the data obtained by further processing the raw data, in the memory 12 via the first bus 181. The accelerator 16 reads the data from the memory 12 and performs the operation to the data to generate the computed data. The generated computed data stores in the memory 12 via the first bus 181. When the accelerator 16 and the processor 14 simultaneously access the memory 12, the accelerator 16 has priority over the processor 14. That is, the accelerator 16 has priority to access the memory 12. This can ensure computational efficiency of the accelerator 16.

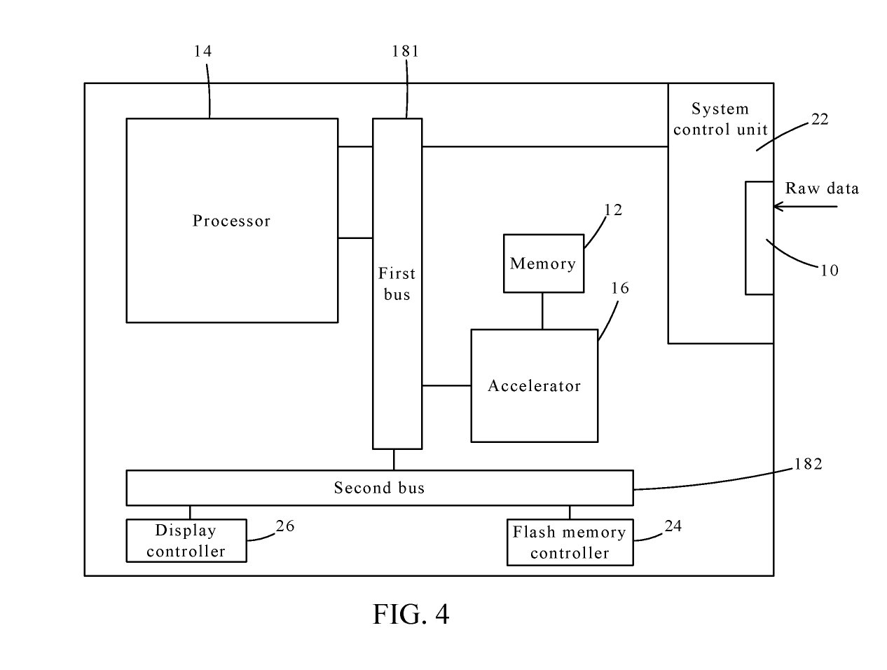

FIG. 4 is a schematic diagram showing an electronic device in accordance with a third embodiment of the present disclosure. Compared with the second embodiment, the memory 12 of the third embodiment is directly connected to the accelerator 16 that is coupled to the processor 14 via the first bus 181. In the third embodiment, the processor 14 and the accelerator 16 share the memory 12. The processor 14 stores the data in the memory 12 via the accelerator 16. The computed data generated by performing the operation to the data by the accelerator 16 also stores in the memory 12. The processor 14 can read the computed data from the memory 12 via the accelerator 16. For the memory 12, the accelerator 16 has a higher access priority than the processor 14 does.

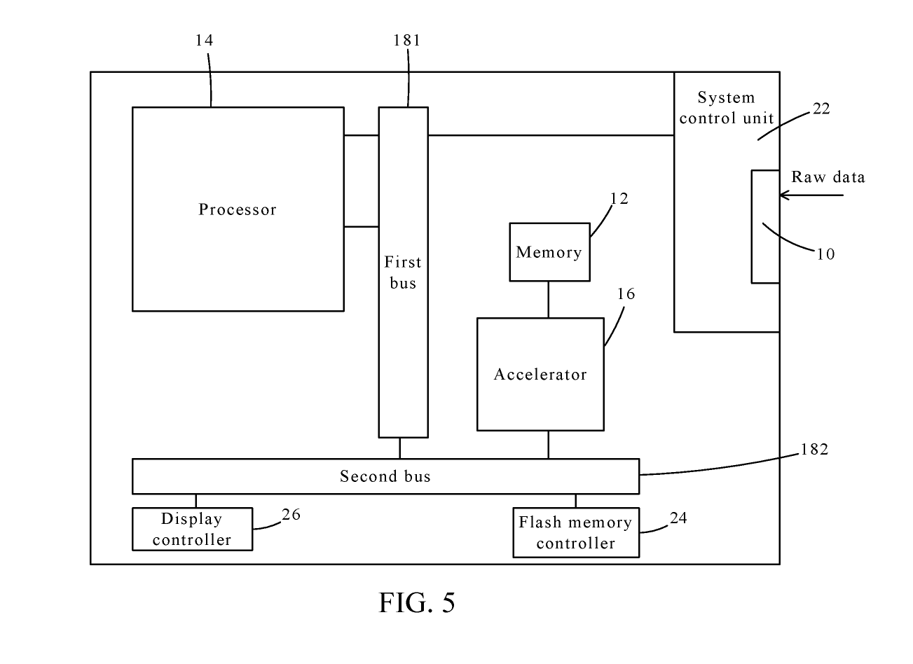

FIG. 5 is a schematic diagram showing an electronic device in accordance with a fourth embodiment of the present disclosure. Compared with the third embodiment, the accelerator 16 of the fourth embodiment is coupled to the processor 14 via the second bus 182. Transmission speed of the second bus 182 is lower than the transmission speed of the first bus 181. That is, the accelerator 16 is not limited to be connected to a high-speed bus connected to the processor 14 but can be configured to be connected to a peripheral bus. In the fourth embodiment, the processor 14 and the accelerator 16 can be integrated into a system on a chip (SoC).

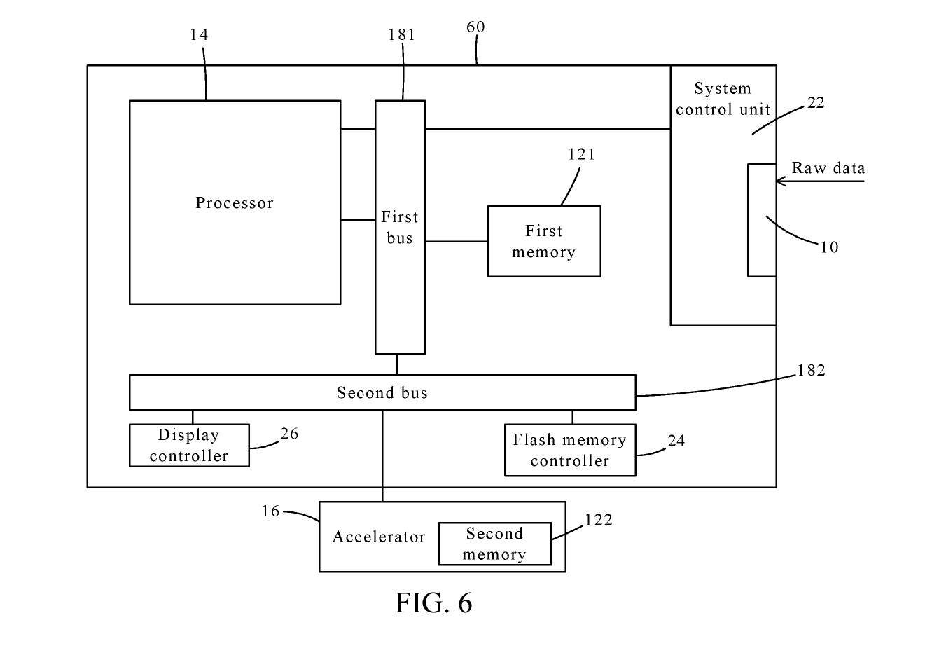

FIG. 6 is a schematic diagram showing a CNN accelerating system of the present disclosure. The CNN accelerating system of the present disclosure includes a system control chip 60 and an accelerator 16. The system control chip 60 includes a processor 14, a first memory 121, a first bus 181, a second bus 182, and a data transmitting interface 10. The system control chip 60 can be a SoC chip. The accelerator 16 serves as a plug-in connected to the system control chip 60. Specifically, the accelerator 16 is connected to a peripheral bus (i.e., the second bus 182) of the system control chip 60, and the accelerator 16 can have a memory of its own (i.e., a second memory 122 shown in FIG. 6).

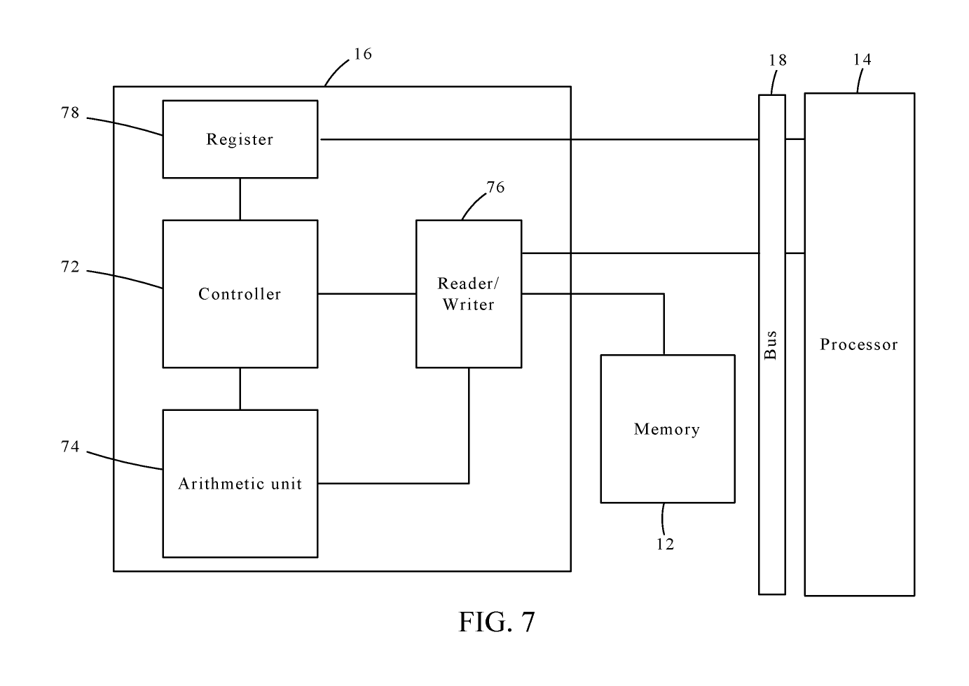

Referring to FIG. 7, the accelerator 16 of the present disclosure includes a controller 72, an arithmetic unit 74, a reader/writer 76, and a register 78. The reader/writer 76 is coupled to the memory 12. The accelerator 16 can access the memory 12 through the reader/writer 76. For example, by using the reader/writer 76, the accelerator 16 can read the raw data or the data stored in the memory 12 and the generated computed data can be stored in the memory 12. The reader/writer 76 can be coupled to the processor 14 via the bus 18. In such a way, through the reader/writer 76 of the accelerator 16, the processor 14 can store the raw data or the data in the memory 12 and read the computed data stored in the memory 12.

The register 78 is coupled to the processor 14 via the bus 18. A bus coupled to the register 78 and a bus coupled to the reader/writer 76 can be different buses. That is, the register 78 and the reader/writer 76 are coupled to the processor 14 via different buses. When the processor 14 executes the neural network application program for example and the firmware driver are executed, some parameters may be written to the register 78. For example, these parameters are parameters related to the neural network operation, such as data width, data depth, kernel width, kernel depth, and loop count. The register 78 may also store some control logic parameters. For example, a parameter CR_REG includes a Go bit, a Relu bit, a Pave bit, and a Pmax bit. According to the Go bit, the controller 72 determines whether to perform the neural network operation. Whether the neural network operation contains ReLu operation, Max Pooling operation, or Average Pooling operation is determined according to the Relu bit, the Pave bit, and the Pmax bit.

The controller 72 is coupled to the register 78, the reader/writer 76, and the arithmetic unit 74. The controller 72 is configured to operate based on the parameters stored in the register 78 to determine whether to control the reader/writer 76 to access the memory 12, and to control operation flow of the arithmetic unit 74. The controller 72 can be implemented by a finite-state machine (FSM), a micro control unit (MCU), or other types of controllers.

The arithmetic unit 74 can perform an operation related to the neural network, such as Convolution operation, ReLu operation, Average Pooling operation, and Max Pooling operation. Basically, the arithmetic unit 74 includes a multiply-accumulator which can multiply each record of the data by a weight coefficient and sum them up. In the present disclosure, the arithmetic unit 74 may have different configurations based on different applications. For example, the arithmetic unit 74 may include various types of operation logic and may include an adder, a multiplier, an accumulator, or their combinations. The arithmetic unit 74 may support various data types that may include unsigned integer, signed integer, and floating-point numbers, but are not limited thereto.

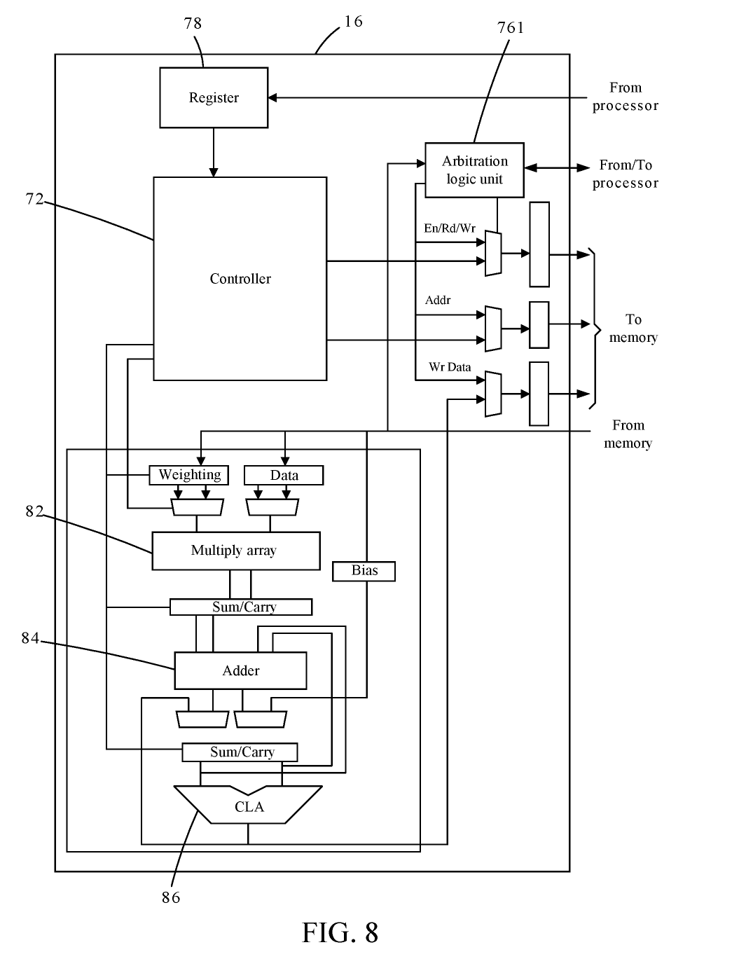

FIG. 8 is a schematic diagram showing the accelerator of the present disclosure in more detail. As shown in FIG. 8, the reader/writer 76 includes an arbitration logic unit 761. When the accelerator 16 and the processor 14 are to access the memory 12, they will send an access request to the arbitration logic unit 761. In one embodiment, when the arbitration logic unit 761 simultaneously receives the requests sent by the accelerator 16 and the processor 14 to access the memory 12, the arbitration logic unit 761 will give the accelerator 16 priority to access the memory 12. That is, for the memory 12, the accelerator 16 has a higher access priority than the processor 14 does.

The arithmetic unit 74 includes a multiply array 82, an adder 84, and a carry-lookahead adder (CLA) 86. During computation, the arithmetic unit 74 will first read the data and corresponding weighs from the memory 12. The data can be an input in a zeroth layer or an output from a previous layer in the neural network. Next, the data and the weights expressed in binary numbers are input to the multiply array 82 to perform a multiply operation. For example, a record of the data is represented by a1a2, its corresponding weighting is represented by b1b2, and the multiply array 82 will obtain a1b1, a1b2, a2b1, and a2b2. The adder 84 is used to calculate a sum of the products, i.e., D1=a1b1+a1b2+a2b1+a2b2. The result is then outputted to the carry-lookahead adder 86. The multiply array 82 and the adder 84 can sum the products up in one time. This avoids intermediate calculations and thus reduce the time to access the memory 12. Next, a similar operation is performed to a next record of the data and its corresponding weighting to obtain D2. The carry-lookahead adder 86 is used to sum up the output values from the adder 84 (i.e., S1=D1+D2) by taking a sum of the values as an input and adding up the sum and a value output by the adder 84 (e.g., S2=S1+D3). Finally, the carry-lookahead adder 86 sums up the accumulated value and a read of the bias value from the memory 12, for example, Sn+b, where b is the bias.

During the computation, the arithmetic unit 74 of the present disclosure does not have to store results of the intermediate calculations to the memory 12 and reads them back to proceed next calculations. Accordingly, the present disclosure avoids frequent accessing to the memory 12, decreasing computing time while improving computational efficiency.

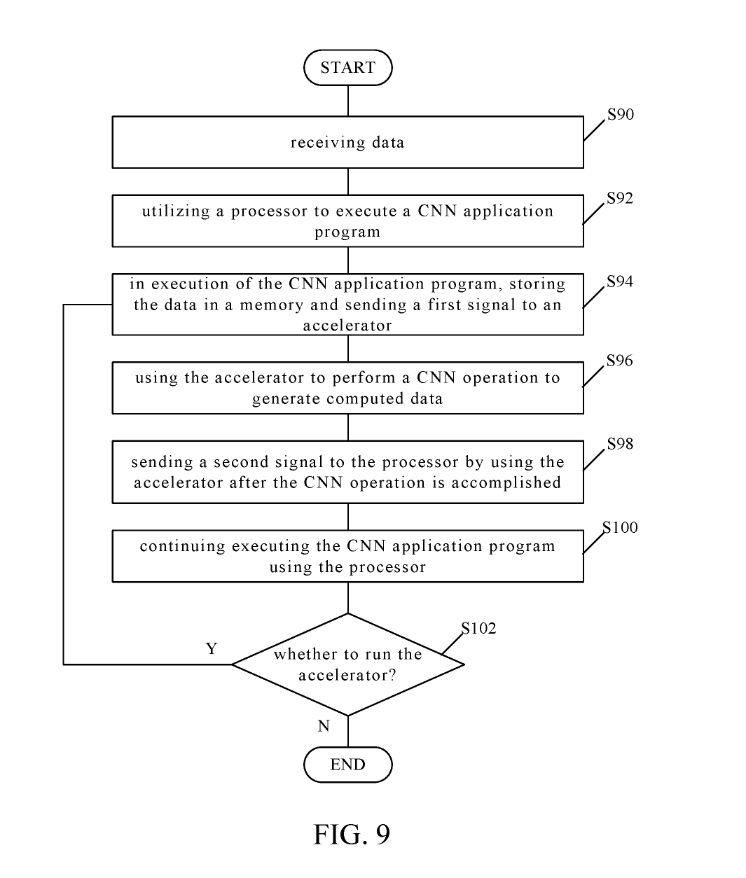

FIG. 9 is a flow chart of an accelerating method applicable to a CNN operation in accordance with the present disclosure. Referring to FIG. 9 with reference to the afore-described electronic device, the accelerating method of the present disclosure includes the following steps:

In step S90, data is received. The data is the data to be computed using the accelerator 16. For example, a sensor is used to capture a sensing data such as ECG data. The sensing data can be used as input data as-is or further processed with filtering, noise reduction, and/or time-frequency domain conversion before being used as data.

In step S92, the processor 14 is utilized to execute a CNN application program. After receiving the data, the processor 14 can execute the CNN application program based on a request for interrupt.

In step S94, in execution of the CNN application program, the data is stored in the memory 12 and a first signal is sent to the accelerator 16. In this step, the CNN application program writes the data, the weights, and the biases into the memory 12. The CNN application program can accomplish these copy operations by the firmware driver. The firmware driver may further copy the parameters (e.g., pointer, data width, data depth, kernel width, kernel depth, and computation types) required by the computation to the register 78. When all necessary data are ready, the firmware driver can send the first signal to the accelerator 16 to start the accelerator 16 to perform the operation. The first signal is an operation request signal. For example, the firmware driver may set the Go bit as true to start the CNN operation. The Go bit is contained in CR REG of the register 78 of the accelerator 16.

Meanwhile, the firmware driver may send a wait-for-interrupt (WFI) instruction to the processor 14 to put the processor 14 into an idle state to save power. In this way, when the accelerator 16 performs the operation, the processor 14 runs in a lower power state. The processor 14 may exit the idle state and restore back to an operation mode when receiving an interrupt signal.

The firmware driver can also send a signal to the system control unit 22. Based on this signal, the system control unit 22 can selectively lower the processor clock or completely disable it so as to transition the processor 14 into a power saving mode from the operation mode. For example, the firmware driver can determine whether to lower or disable the processor clock by determining whether the number of loops of the CNN operation requested to be executed is larger than a pre-set threshold.

In step S96, the accelerator 16 is used to perform the CNN operation to generate computed data. For example, when the controller 72 of the accelerator 16 detects that the Go bit in CR_REG of the register 78 is true, the controller 72 controls the arithmetic unit 74 to perform the CNN operation to the data to generate the computed date. The CNN operation may include Convolution operation, ReLu operation, Average Pooling operation, and Max Pooling operation. The arithmetic unit 74 may support various data types that may include unsigned integer, signed integer, and floating point, but are not limited thereto.

In step S98, the accelerator 16 sends a second signal to the processor 14 after the CNN operation is accomplished. When the CNN operation is accomplished, the firmware driver may set the Go bit of CR_REG of the register 78 as false to terminate the CNN operation. Meanwhile, the firmware driver can inform the system control unit 22 to restore the processor clock back to common clock frequency and the accelerator 16 sends an interrupt request to the processor 14 such that the processor 14 restores back to the operation mode from the idle state.

In step S100, the processor 14 continues executing the CNN application program. After restoring back to the operation mode, the processor 14 continues executing the rest of the application program.

In step S102, processor 14 determines whether to run the accelerator 16. If yes, the processor 14 sends a third signal to the accelerator 16 and goes back to step S94. If no, the process is terminated. The CNN application program determines whether there are more data to be processed using the accelerator 16. If yes, the third signal is sent to the accelerator 16 and the input data are copied to the memory 12 for performing the CNN operation. The third signal is an operation request signal. If no, the accelerating process is terminated.

Above all, while the preferred embodiments of the present disclosure have been illustrated and described in detail, various modifications and alterations can be made by persons skilled in this art. The embodiment of the present disclosure is therefore described in an illustrative but not restrictive sense. It is intended that the present disclosure shall not be limited to the particular forms as illustrated, and that all modifications and alterations that maintain the spirit and realm of the present disclosure are within the scope as defined in the appended claims.

1. An electronic device, comprising:
a data transmitting interface configured to transmit data;
a memory configured to store the data;
a processor configured to execute an application program; and
an accelerator coupled to the processor via a bus, and according to an operation request transmitted from the processor, the accelerator is configured to read the data from the memory, perform an operation to the data to generate computed data, and store the computed data in the memory,
wherein the processor is in a power saving state when the accelerator performs the operation.

2. The electronic device according to claim 1, wherein the memory comprises a first memory directly connected to the accelerator.

3. The electronic device according to claim 2, wherein the memory comprises a second memory coupled to the processor via the bus.

4. The electronic device according to claim 3, wherein the data is stored in the first memory and the computed data is stored in the second memory.

5. The electronic device according to claim 3, wherein the data and the computed data are stored in the first memory, and the second memory stores data related to the application program.

6. The electronic device according to claim 1, wherein the memory is coupled to the processor via the bus, both the data and the computed data are stored in the memory, and when the accelerator and the processor simultaneously access the memory, the accelerator has priority over the processor.

7. The electronic device according to claim 1, wherein the bus comprises a first bus and a second bus, transmission speed of the first bus is higher than the transmission speed of the second bus, and both the processor and the accelerator are coupled to the first bus.

8. The electronic device according to claim 7, wherein the accelerator is coupled to the processor via the second bus.

9. The electronic device according to claim 1, further comprising a system control unit, wherein the data transmitting interface is disposed in the system control unit.

10. The electronic device according to claim 1, wherein the processor optionally operates under an operation mode and a power saving mode, and the processor is in the power saving mode when the accelerator performs the operation.

11. The electronic device according to claim 1, wherein the operation comprises Convolution operation, Rectified Linear Units (ReLu) operation, and Max Pooling operation.

12. The electronic device according to claim 1, wherein the accelerator comprises:
a controller;
a register configured to store a plurality of parameters required by the operation;
an arithmetic unit configured to perform the operation; and
a reader/writer configured to perform reading and/or writing operations to the memory.

13. The electronic device according to claim 12, wherein the arithmetic unit comprises a multiply-accumulator.

14. The electronic device according to claim 12, wherein the reader/writer reads the data and corresponding weights from the memory and writes the computed data to the memory.

15. An accelerator for performing a neural network operation to data in a memory, comprising:
a register configured to store a plurality of parameters related to the neural network operation;
a reader/writer configured to read the data from the memory;
a controller coupled to the register and the reader/writer; and
an arithmetic unit coupled to the controller, based on the parameters, the controller controlling the arithmetic unit to perform the neural network operation to the data to generate computed data.

16. The accelerator according to claim 15, wherein the reader/writer comprises an arbitration logic unit configured to receive a request to access the memory and allow the accelerator to have priority to access the memory.

17. The accelerator according to claim 15, wherein the arithmetic unit comprises:
a multiply array configured to receive the data and corresponding weighs and perform multiplication to the data and the weights;
an adder configured to sum up products; and
a carry-lookahead adder (CLA) configured to sum up values outputted by the adder by taking a sum of the values as an input and adding up the sum and a value outputted by the adder.

18. The accelerator according to claim 15, wherein the computed data is directly transmitted to the memory and stored in the memory.

19. An accelerating method applicable to a neural network operation, comprising:
(a) receiving data;
(b) utilizing a processor to execute a neural network application program;
(c) in execution of the neural network application program, storing the data in a memory and sending a first signal to an accelerator;
(d) using the accelerator to perform the neural network operation to generate computed data;
(e) sending a second signal to the processor by using the accelerator after the neural network operation is accomplished;
(f) continuing executing the neural network application program using the processor; and
(g) determining whether to run the accelerator; if yes, the processor sends a third signal to the accelerator and goes back to step (d); if no, terminate the process.

20. The accelerating method according to claim 19, wherein step (d) comprises:
sending a wait-for-interrupt (WFI) instruction to the processor to put the processor into an idle state.

21. The accelerating method according to claim 19, wherein in step (e), the second signal represents an interrupt sending from the accelerator to the processor.

22. The accelerating method according to claim 19, wherein step (d) comprises:
sending a fourth signal to a system control unit to put the processor into a power saving mode, and wherein step (e) comprises:
sending a fifth signal to the system control unit to restore the processor back to an operation mode.
